(19) United States
(12) Patent Application Publication
(10) Pub. No.: US 2011/0161827 A1
(43) Pub. Date: Jun. 30, 2011

(54) SOCIAL MEDIA COMMUNICATION AND CONTACT ORGANIZATION

(76) Inventors: Anastasia Dedis, Lutz, FL (US); Panos E. Kontses, Lutz, FL (US)

(21) Appl. No.: 12/980,091

(22) Filed: Dec. 28, 2010

Related U.S. Application Data
(63) Continuation-in-part of application No. 12/398,257, filed on Mar. 5, 2009.
(60) Provisional application No. 61/033,845, filed on Mar. 5, 2008.

(51) Int. Cl. G06F 3/01

(52) U.S. Cl. 715/738

(57) ABSTRACT

An apparatus, system, and method and for social media communication and contact organization. The method includes representing a user contact as a node in an organizational structure on a web-based social networking platform. The organization structure may be associated with a user. The organizational structure may include a base with one or more clusters, each cluster configured to hold one or more nodes. The method includes grouping the node into a particular cluster of the organizational structure. The node includes one or more information channels between the user contact and the user. The method includes graphically depicting the organizational structure. The graphically depicted organizational structure may be responsive to interaction from the user.

### CROSS-REFERENCES TO RELATED APPLICATIONS

This application is a continuation-in-part of and claims priority to U.S. patent application Ser. No. 12/398,257 entitled “Method and System Facilitating Two-Way Interactive Communication and Relationship Management,” filed on Mar. 5, 2009 for Anastasia Dedis, et al., which claims the benefit of U.S. Provisional Patent Application No. 61/033,845 entitled “Method and System Facilitating Two-Way Interactive Communication and Relationship Management” and filed on Mar. 5, 2008 for Anastasia Dedis, et al., which is incorporated herein by reference.

### FIELD

The subject matter of the present application relates to web-based social networking and more particularly relates to social media communication and contact organization on a web-based social networking platform.

### BACKGROUND

The Internet has given rise to web-based social networking and electronic communication. A user may, through a social networking platform, maintain connections with friends, communicate with these friends, post electronic media such as photos and videos, and the like. A user may acquire hundreds of contacts. Moreover, a user typically maintains accounts with multiple social networking platforms, each with its own focus such as social, professional, public, and the like. As a result, the user has to manage multiple accounts, multiple passwords, and redundant contact lists.

In addition, a user may also manage one or more e-mail addresses, each subject to spam and junk mail. Moreover, a user may wish to receive messages from certain merchants, while blocking messages from others. However, a user wishing to share the user's email address with desired merchants may become subject to unsolicited emails from merchants who received the email address from sources besides the user.

### SUMMARY

From the foregoing discussion, it should be apparent that a need exists for an apparatus, system, and method that provide a user with an organizational representation of the user's contacts. Beneficially, such an apparatus, system, and method would manage communication between the user and the user's contacts and other entities.

Accordingly, the present disclosure has been developed in response to the present state of the art, and in particular, in response to the problems and needs in the art that have not yet been fully solved by currently available social networking platforms. Accordingly, the subject matter described herein has been developed to provide an apparatus, system, and method that overcome many or all of the above-discussed shortcomings in the art.

A method is provided for social media communication and contact organization. The method includes representing a user contact as a node in an organizational structure on a web-based social networking platform. The organization structure may be associated with a user. The organizational structure may include a base with one or more clusters, each cluster configured to hold one or more nodes. The method includes grouping the node into a particular cluster of the organizational structure. The node includes one or more information channels between the user contact and the user. The method includes graphically depicting the organizational structure. The graphically depicted organizational structure may be responsive to interaction from the user.

In one embodiment, the organizational structure is graphically depicted as a tree, the base is graphically depicted as a tree trunk, and each node is graphically depicted as a leaf. In one embodiment, the method further includes subscribing the user to one or more information channels for the node and communicating one or more electronic messages through the one or more subscribed information channels. In certain embodiments, the method further includes providing a node interface for display to the user. The node interface may include a visual representation of a plurality of adjustable settings corresponding to the node.

In one embodiment, the method further includes configuring one or more reception settings for the node and/or the one or more information channels. The one or more reception settings may include an update frequency, a message delivery frequency, a message delivery time, and/or subscribed information channels. The method may also include configuring one or more visibility settings for the node, the particular cluster, and/or the organizational structure. The one or more visibility settings may specify appearance and/or visibility to a viewer of the node, the particular cluster and/or the organizational structure. The method may also include configuring one or more access settings for the node, the particular cluster, and/or the organizational structure. The one or more access settings specify access and/or visibility of the node, the particular cluster and/or the organizational structure to the user contact and/or a viewer.

In one embodiment, graphically depicting the organizational structure further includes graphically depicting the organizational structure for a first viewer differently than for a second viewer depending on a viewer identity, organizational structure visibility settings, cluster visibility settings, and/or node visibility settings. In one embodiment, the node is associated with a commercial entity and the method further includes communicating an electronic message from the commercial entity to the user through an information channel of the node and crediting the user with a reward in response to the user accessing the electronic message. The reward may be redeemable for discounts on purchases from the commercial entity and/or additional merchant entities belonging to a common reward ring with the commercial entity.

In one embodiment, the node is associated with a non-participating commercial entity and the method further includes directing an electronic message from the non-participating commercial entity to the user through an information channel of the node. In one embodiment, the method further includes associating an additional node representing an additional user contact with the organizational structure in response to receiving a signal from a commercial entity that the user requested to associate the commercial entity with the organizational structure, detecting the user visually associate a visual representation of the additional node with the graphically depicted organizational structure, and/or detecting the user select the visual representation of the additional node on the social networking platform.

In one embodiment, the node is associated with an employment information source and the method further includes communicating employment information from the employment information source through the one or more information channels. In some embodiments, the method further includes representing an entity contact as an entity node in an additional organizational structure on the social networking platform. The additional organization structure may be associated with an entity. The entity node may represent a user registered to receive employment information from the entity. The additional organizational structure may include a plurality of entity contacts for a plurality of users registered to receive employment information.

In one embodiment, the method further includes delivering unsolicited electronic messages to the user through a predetermined communication channel and crediting the user with a reward in response to the user accessing an unsolicited electronic message. In some embodiments, the method further includes registering a commercial entity on the social networking platform in a direct marketing campaign, granting the commercial entity access to a plurality of consumer profiles for users on the web-based social networking platform according to the direct marketing campaign, receiving a selection of one or more users from the commercial entity, and/or communicating a plurality of unsolicited electronic messages from the commercial entity to the one or more selected users.

In one embodiment, the method further includes registering a commercial entity on the social networking platform in a ranking campaign, displaying a representation for the commercial entity more prominently in relation to representations of one or more additional commercial entities in search results from a search by the user on the web-based networking platform, and/or displaying a visual representation of a node for the commercial entity more prominently on one or more user organizational structures in relation to additional visual representations of nodes on the user organizational structures.

An apparatus is also provided for social media communication and contact organization. The apparatus may include modules configured to carry out at least a portion of the steps of the method. In one embodiment the apparatus includes a structure module to represent a user contact as a node in an organizational structure on a web-based social networking platform. The organization structure may be associated with a user. The organizational structure may include a base with one or more clusters and each cluster may be configured to hold one or more nodes. The apparatus may include a grouping module to associate the node with a particular cluster of the organizational structure. The node may include one or more information channels between the user contact and the user. The apparatus may include a depiction module to prepare the organizational structure for graphical depiction. The graphically depicted organizational structure may be responsive to interaction from the user.

A system is also provided for social media communication and contact organization. The system may include system components configured to also carry out at least a portion of the steps of the method. In one embodiment, the system includes a server configured to communicate with one or more clients over a network. The server may include a structure module to represent a user contact as a node in an organizational structure on a web-based social networking platform. The organization structure may be associated with a user. The organizational structure may include a base with one or more clusters; each cluster may be configured to hold one or more nodes. The server may include a grouping module to group the node into a particular cluster of the organizational structure. The node includes one or more information channels between the user contact and the user. The server may include a depiction module to graphically depict the organizational structure. The graphically depicted organizational structure may be responsive to interaction from the user.

A computer program product is also presented for social media communication and contact organization. The computer program product may be configured to carry out at least a portion of the steps of the method. In one embodiment, the computer program product includes maintaining a user contact as a node in an organizational structure on a web-based social networking platform. The organization structure may be associated with a user. The organizational structure may include a base with one or more clusters, each cluster configured to hold one or more nodes. The computer program product may include categorizing the node into a particular cluster of the organizational structure based on a user selection. The node may include one or more information channels between the user contact and the user. The computer program product may include graphically representing the organizational structure. The graphically depicted organizational structure may be responsive to interaction from the user.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the features, advantages, and characteristics of the subject matter described herein may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

### BRIEF DESCRIPTION OF THE DRAWINGS

The appended drawings depict embodiments of the subject matter disclosed herein and are not therefore to be considered to be limiting of its scope, the subject matter will be described and explained with additional specificity and detail through the use of the accompanying drawings, in which:

FIG. 1 is a schematic block diagram illustrating one embodiment of a system for social media communication and contact organization;

FIG. 2 is a detailed schematic block diagram illustrating another embodiment of a system for social media communication and contact organization;

FIG. 3 is a schematic block diagram illustrating one embodiment of an apparatus for social media communication and contact organization;

FIG. 4 is a schematic block diagram illustrating one embodiment of a graphically depicted organizational structure in accordance with the present subject matter;

FIG. 5 is a schematic block diagram illustrating another embodiment of a graphically depicted organizational structure in accordance with the present subject matter;

FIG. 6 is a schematic block diagram illustrating one embodiment of a graphically depicted organizational structure with cluster areas in accordance with the present subject matter;

FIG. 7 is a schematic block diagram illustrating one embodiment of a graphically depicted organizational structure with nodes in cluster areas in accordance with the present subject matter;

FIG. 8 is a schematic block diagram illustrating one embodiment of an interface with graphically depicted organizational structures in accordance with the present subject matter;

FIG. 9 illustrates one embodiment of a visual representation of an update interface of a commercial environment;

FIG. 10 illustrates one embodiment of a visual representation of a brands interface of a commercial environment;

FIG. 11 is a detailed schematic block diagram illustrating another embodiment of an apparatus for social media communication and contact organization;

FIG. 12 illustrates one embodiment of a visual representation of a rewards interface of a commercial environment;

FIG. 13A illustrates one embodiment of a node interface with reception settings for a social environment in accordance with the present subject matter;

FIG. 13B illustrates one embodiment of a node interface with reception settings for a commercial environment in accordance with the present subject matter;

FIG. 13C illustrates one embodiment of a node interface with reception settings for a professional environment in accordance with the present subject matter;

FIG. 14A illustrates one embodiment of a node interface with visibility settings for a social environment in accordance with the present subject matter;

FIG. 14B illustrates one embodiment of a node interface with visibility settings for a commercial environment in accordance with the present subject matter;

FIG. 14C illustrates one embodiment of a node interface with visibility settings for a professional environment in accordance with the present subject matter;

FIG. 15A illustrates one embodiment of a node interface with access settings for a social environment in accordance with the present subject matter;

FIG. 15B illustrates one embodiment of a node interface with access settings for a commercial environment in accordance with the present subject matter;

FIG. 15C illustrates one embodiment of a node interface with access settings for a professional environment in accordance with the present subject matter;

FIG. 16A illustrates one embodiment of a node interface with access settings for an employment environment in accordance with the present subject matter;

FIG. 16B illustrates one embodiment of a node interface with access settings for an employment environment in accordance with the present subject matter;

FIG. 16C illustrates one embodiment of a node interface with access settings for an employment environment in accordance with the present subject matter;

FIG. 17 is a schematic flow chart diagram illustrating one embodiment of a method for social media communication and contact organization;

FIG. 18 is a detailed schematic flow chart diagram illustrating another embodiment of a method for social media communication and contact organization;

FIG. 19 is a detailed schematic flow chart diagram illustrating another embodiment of a method for social media communication and contact organization;

FIG. 20 is a schematic flow chart diagram illustrating one embodiment of a method for a direct marketing campaign; and

FIG. 21 is a schematic flow chart diagram illustrating one embodiment of a method for a ranking campaign.

### DETAILED DESCRIPTION

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, and scripting languages such as Flash Action Script, PHP, JavaScript, Ruby and AJAX. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

Aspects of the present subject matter are described below with reference to schematic flowchart diagrams and/or schematic block diagrams of methods, apparatuses, systems, and computer program products according to embodiments of the subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

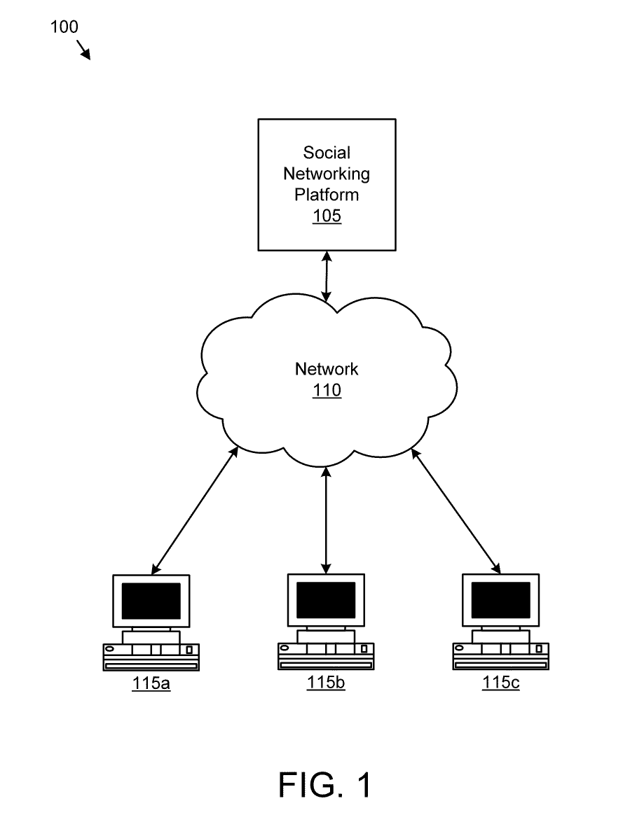

FIG. 1 depicts one embodiment of a system 100 for social media communication and contact organization. The system 100 includes a social networking platform 105, a network 110, and a plurality of clients 115. The social networking platform 105 may host, store, and/or provide web-based social networking and/or a web-based social networking website for access over the network 110 by the plurality of clients 115. The social networking platform 105 may include and/or be implemented by servers, storage, databases, and other infrastructure. One or more servers comprising the social networking platform 105 may be embodied as a computing device including a desktop computer, a portable computer, a server, a mainframe computer, and the like. The one or more servers may include memory storing computer readable programs and may include a processor that executes the computer readable programs as is well known to those skilled in the art. The computer readable programs may be tangibly stored in storage in communication with the server one or more servers. The one or more servers may host, store, and/or provide the social networking website for access, and/or download over the network 110 by the plurality of clients 115 as is known in the art.

References herein to the social networking platform 105 may also include references to one or more businesses, organizations, and/or personnel that host, support, and/or operate the social networking website. Moreover, the social networking platform 105 may, in certain embodiments, be similar to and/or share at least a portion of the functions of the social networking platform 105 described in U.S. patent application Ser. No. 12/980,058 entitled “Social Media Communication and Relationship Management,” filed on Dec. 28, 2010 for Anastasia Dedis et al. (hereinafter the “Other Application”), which is incorporated herein by reference.

The network 110 may comprise a global communications network such as the Internet, a Local Area Network (LAN), multiple LANs communicating over the internet, or any other similar communications network. Each client 115 may be embodied as a desktop computer, a portable computer, a server, a mainframe computer, a handheld computing device, a touch device, a personal desktop assistant (“PDA”), a tablet computer, an eBook reader, a mobile phone, a Smartphone, and the like.

Each client 115 may communicate with the social networking platform 105 through the network 110. In one embodiment, a client 115 communicates with the social networking platform 105 with an application, such as an Internet browser, executing on the client 115 and accesses and/or downloads web pages of the social networking website as is known in the art.

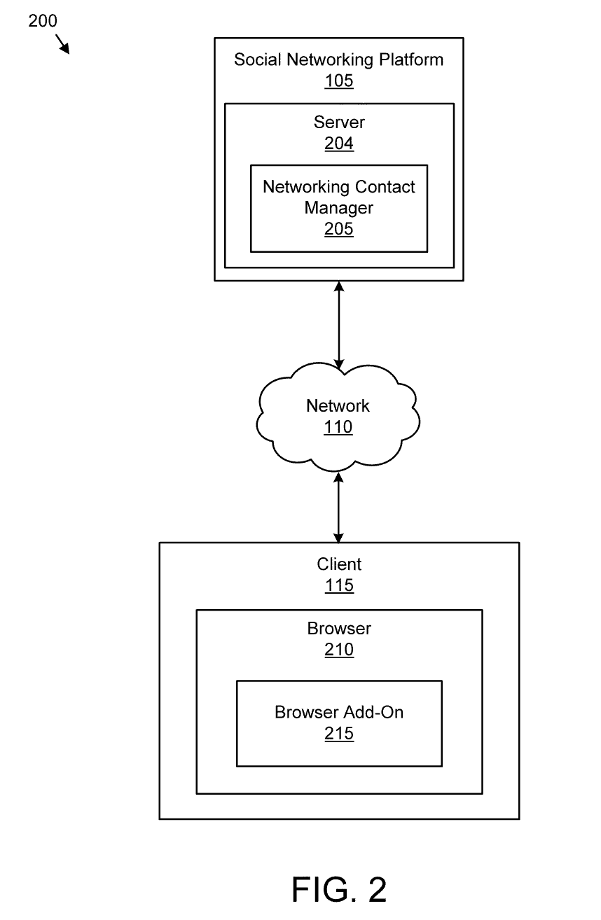

FIG. 2 depicts a detailed embodiment of a system 200 for social media communication and contact organization. The description of the system 200 refers to elements of FIG. 1, like numbers referring to like elements. The system 200 includes a social networking platform 105 that may be substantially similar to the social networking platform 105 depicted in FIG. 1. Moreover, the system 200 may, in certain embodiments, be similar to and/or share at least a portion of the functions of the system 200 described in the Other Application.

The social networking platform 105 includes a server 204 with a networking contact manager 205. Furthermore, the networking contact manager 205 may be similar to and/or share at least a portion of the functions and/or modules of the social networking manager 205 described in the Other Application. The social networking platform 105 is in communication with a network 110 in communication with a client 115. The network 110 and the client 115 may be substantially similar to the like numbered elements in FIG. 1. Furthermore, the client 115 includes a browser 210 with a browser add-on 215. The browser 210 may be embodied as an application configured to present, access and/or download web pages as is known in the art. In one embodiment, the browser add-on 215 may be similar to and/or share at least a portion of the functions and/or modules of the browser add-on 215 described in the Other Application.

The networking contact manager 205 may include all or a portion of the social networking website. Furthermore, the social networking website may be embodied as one or more web pages available for access over the network 120. Each web page may include software code, images, and text as is known in the art. Specifically, each web page may include static and/or dynamic elements and include Hypertext Markup Language (“HTML”) code, JavaScript code, Flash animations, and the like.

The following description refers to a single user. The actions and description of the single user may also apply to a plurality of users. The networking contact manager 205 may allow a user to join a social networking website and create a user account to interact with the social networking website. In addition, the user may form associations with one or more entities such as other users and/or commercial entities. Specifically, the user may associate an entity with the user's user account (e.g. adding the entity as a contact). The networking contact manager 205 may provide a user with an organizational structure to manage the user's contacts, allowing the user to group contacts within the organizational structure. The organizational structure may be graphically depicted and responsive to interaction from the user, thus enabling the user to visualize and manage the user's contacts in a convenient manner.

In response to the user associating an entity with the user's organizational structure, the networking contact manager 205 may form a communication channel between the user (e.g. the user account) and the entity (e.g. the entity's account). The user and the entity may exchange electronic communications through the communication channel. In one embodiment, a user receives rewards from receiving and/or accessing electronic messages from commercial entities. The user may use the rewards for purchases with the commercial entity (or other participating commercial entities affiliated with the commercial entity).

In addition, the networking contact manager 205 may combine multiple communication environments—that include contacts/connections, content, and the like—for different types of entities, such as a user's public entities, social entities, commercial entities, and the like. The networking contact manager 205 may provide a distinct organizational structure for each communication environment. The networking contact manager 205 may insulate each environment from one another so that, for example, a professional contact is prevented from viewing contacts on the organizational structure for the user's social environment. As a result, a user may maintain contacts for the user's various aspects of life in a single social networking platform 105 instead of having multiple accounts with multiple other platforms.

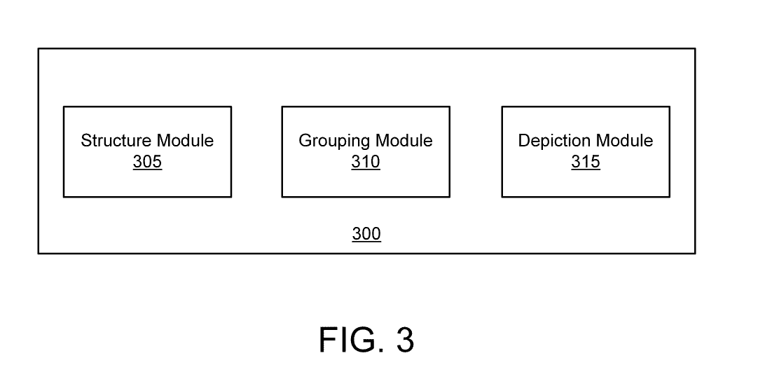

FIG. 3 depicts one embodiment of an apparatus 300 for social media communication and contact organization. Specifically, the apparatus 300 may comprise one embodiment of the networking contact manager 205. The description of the apparatus 300 refers to elements of FIGS. 1-2, like numbers referring to like elements. The depicted apparatus 300 includes a structure module 305, a grouping module 310, and a depiction module 315. Moreover, while the depicted embodiment includes the above listed modules, in certain embodiments, the apparatus 300 may include a subset of the depicted modules alone and/or in various combinations.

The structure module 305 represents and/or maintains a user contact as a node in an organizational structure on a web-based social networking platform 105. The organizational structure may be associated with a user and include a base with one or more clusters, each cluster configured to hold one or more nodes. Each node may represent and/or store information about a user contact—a user's social contact, professional contact, commercial contact, and the like. Consequently, each node and/or organizational structure, in one embodiment, is classified as being associated with a contact type (e.g. social, professional, and the like) as specified by the user and/or as a default setting. In addition, each node may be differently configured (different selectable options, different information channels, and the like) depending on the contact type. The structure module 305 may maintain the organizational structure as part of a user's account on the social networking platform 105/social networking website. Furthermore, the structure module 305 may store the organizational structure and associated node and contact information in a database on the social networking platform 105 (e.g. a database in communication with the server 204).

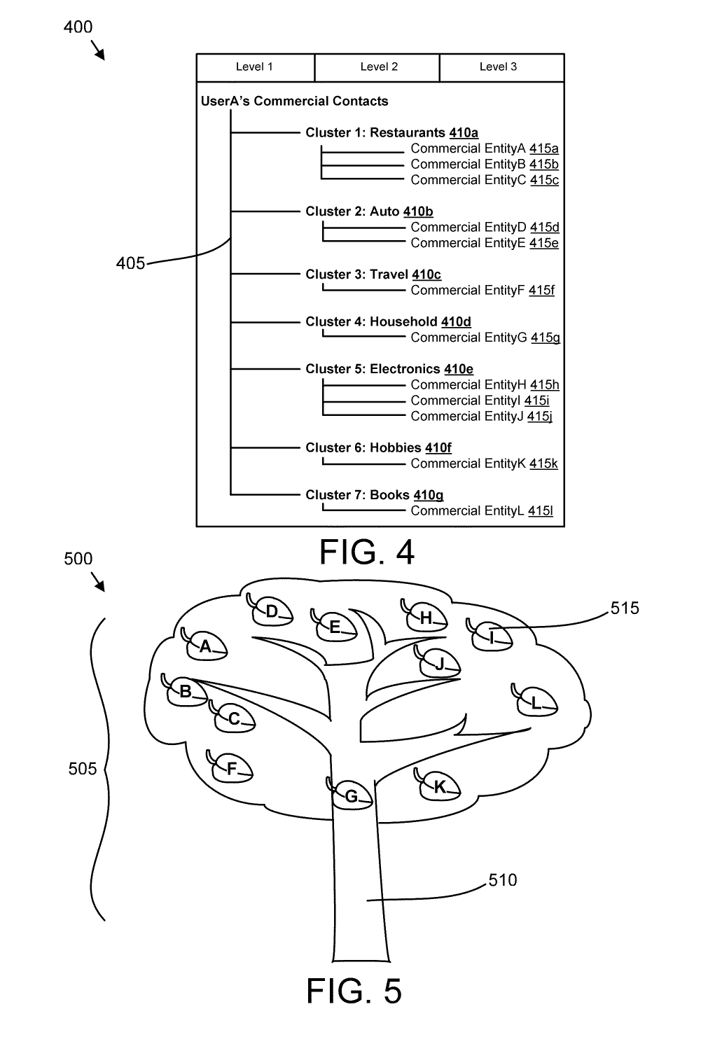

FIG. 4 depicts one embodiment of an organizational structure 400. The depicted organizational structure 400 includes a base 405, clusters 410, and nodes 415. Specifically, the organizational structure 400 in FIG. 4 includes a plurality of nodes 415 for user contacts (commercial entities) grouped in the clusters 410 (described below).

The organizational structure 400 may be configured to be visually and/or graphically depicted in various forms described below. Referring to FIG. 5, in one embodiment, the organizational structure 500 is graphically depicted as a tree 505, the base is graphically depicted as a tree trunk 510, and each node is graphically depicted as a leaf 515. The tree in FIG. 5 is of course one embodiment and the tree 505 may be graphically depicted in any suitable form. Referring back to FIG. 3, the structure module 305 may also store visual information related to the organizational structure for use when the organizational structure is graphically depicted.

In one embodiment, the structure module 305 may associate a node with the organizational structure and/or place a node in the organizational structure through various means. In one embodiment, the structure module 305 may associate node representing a user contact with the organizational structure in response to receiving a signal from a commercial entity (e.g. a commercial entity's website) that the user requested to associate the commercial entity with the user's organizational structure, detecting the user visually associate a visual representation of the node with the graphically depicted organizational structure (e.g. the user drags and drops a leaf into the tree), and/or detecting the user select the visual representation of node for the commercial entity on the social networking platform 105 (e.g. the user clicks on a leaf, an/or other visual indicator of an entity on a web page of the social networking website to add the entity as a user contact).

For example, the structure module 305 may receive an indication from a commercial entity's website that the user has requested to add a node representing the commercial entity (e.g. the user clicks on a leaf and/or other visual indicator on the commercial entity's website, the commercial entity's website then sends a message to the structure module 305). The structure module 305 may then associate a node with the organizational structure in response to receiving the indication. For example, a user may browse a web page of a national retail store chain. The user sees a leaf on the web page instructing the user to click the leaf to add the retail store chain to the user's tree. The user clicks the leaf and the structure module 305 adds the leaf to the user's tree on the social networking platform 105. In one embodiment, the commercial entity website and/or structure module 305 requests a password and/or other suitable identification credential from the user to verify the identity of the user desiring to add the node.

Specifically, in one embodiment, to add nodes to a user's organizational structure, the user may search/browses web pages (e.g. web pages on the social networking platform 105 and/or third party web pages such as commercial entity web pages) where visual representations of nodes may be found (e.g. a graphical image of a leaf with an indication that the leaf pertains to a specific entity) based on various keywords and criteria. When a desired node is found, in one embodiment, the user may select the visual representation of the node (e.g. click on a “+” sign on the leaf) to add the node to the user's organizational structure. In one embodiment, a node for a commercial entity, celebrity, and the like may be added from web pages, e-mails, and the like in this manner.

In one embodiment, when a user selects a visual representation of a node, a user may write a message to the entity corresponding to the node (e.g. a pop up window opens allowing user to write a message that will escort the invitation sent to a leaf owner). A node entity may receive an invitation along with a link enabling the entity to view the user's profile. In one embodiment, the structure module 305 stores a temporary node in association with the organizational structure until the invitation is accepted/rejected.

A node entity owner may accept the invitation and the structure module 305 may place nodes representing each party in each party's organizational structures (e.g. both users' organizational structures receive a corresponding node for final placement on both party's organizational structures as described below). In some embodiments, a user may ignore invitations, save them for later, reject them, block the sender, and the like.

In addition, the user may add a node to the user's organizational structure through any suitable means. For example, a user may manually add a node for an entity. A user may request, through an indicator on web pages of the social networking platform 105, to add a contact manually. In one embodiment, the user may be prompted with fields to enter a contact name, email address, and/or message to send an invitation to an additional entity.

In one embodiment, the structure module 305 searches for the additional entity on the social networking platform 105 (e.g. in a database of users on the social networking platform 105) and sends the invitation to the entity through communication channels on the social networking platform 105. In one embodiment, if the structure module 305 does not locate the additional entity on the social networking platform 105, the structure module 305 may send the invitation through e-mail, text message, and the like based on contact information supplied by the user.

In one embodiment, the structure module 305 may delete nodes in response to a user selecting a node for deletion and/or the node entity deleting the user's node from the node entity's organizational structure. For example, if Billy has a leaf representing Sally on his tree and vice versa, if Sally deletes Billy's leaf from her tree, the structure module 305 may also delete Sally's leaf on Billy's, severing the association and the visual representation of the association.

In one embodiment, when the structure module 305 associates a node on an organizational structure, then a relationship is formed between the node entity (e.g. the entity represented by the node) and the user. In one embodiment, the structure module 305 creates a communication channel between the user and the node entity for as long as the node is associated with the organizational structure.

As used herein, a communication channel is an established communication path between entities on the social networking platform 105. The entities may include users (each with a corresponding user account), commercial entities (each with a corresponding commercial entity account), and the like. Furthermore, a communication channel may include one or more information channels, which are categories, types, and/or feeds that make up a particular communication channel. For example, a user may establish a communication channel with a grocery store commercial entity. The grocery store commercial entity may configure multiple information channels to which the user can subscribe to receive electronic communication/messages on various subjects: clearance items, coupons, and news. When the grocery store sends an electronic message through the information channel “news” and the user has subscribed to that information channel, the user may receive the electronic message. In one embodiment, a node is associated with an employment information source and the user may receive employment related communication through the communication channel associated with the node.

In one embodiment, the social networking platform 105 may form a communication channel between a user and an additional user, a commercial entity, and/or other entities. The social networking platform 105 may also form a communication channel between a commercial entity and an additional commercial entity. Furthermore, in one embodiment, the communication channel is a two-way communication channel. Specifically, the commercial entity may communicate electronic messages to a recipient such as a non-commercial user, other commercial entity, and/or other entity. These electronic messages may be in the form of direct messages specific to the recipient, messages for multiple recipients, updates, and the like. An update may comprise a notification of an action that an entity has taken, a change in an entity's status, a post by an entity, and the like. In addition, a user may communicate information to a commercial entity through the communication channel. In one embodiment, the information that a user may communicate to a commercial entity is limited. For example, a user may communicate preference information to specify what products the user wishes to receive information about, but not communicate personal information.

In one embodiment, each node and/or visual representation of a node includes and/or is associated with a user-controlled communication feed between the user and the user contact, entity information about the user contact, commercial relationships, contact information, a visual representation of a company logo (e.g. for commercial entities), a reward indicator, and/or a received message indicator.

In one embodiment, each node may include a node “type” or classification. For example, a node may be classified as a social node, professional node, and the like. The type may be specified by the user and/or a default setting. In one embodiment, the structure module 305 represents nodes of various types in a single organizational structure. In another embodiment, the structure module 305 creates a plurality of organizational structures for the user, each organizational structure directed at different types of contacts. In one embodiment, the structure module 305 creates organizational structures for public, social, commercial, and/or professional contacts. In one embodiment, the social networking platform 105 includes a plurality of communication environments as described in the Other Application. In certain embodiments, each communication environment includes one or more organizational structures specific to that communication environment (e.g. the user's social communication environment includes a user's social tree).

As described in the Other Application, the plurality of communication environments may include, but are not limited to a public environment, a social environment, a commercial environment, neighborhood environment, and/or a professional environment. The public environment may include a “broadcasting” environment in which a user may receive electronic messages/content from contacts that the user is “following.” The public environment may also facilitate a user broadcasting electronic messages/content to contacts (“followers”) that “follow” the user. The social environment may include a user's social friends as contacts, allowing the exchange of electronic messages/content between the user's and the user's friends. User contacts in the social environment may be referred to as “friends.”

The commercial environment may allow a user to form associations with commercial entities as described above. User contacts in the commercial environment may be referred to as “brands.” The professional environment may allow a user to form connections with professional and/or employment related contacts such as individuals, commercial entities, hiring firms, and the like. User contacts in the commercial environment may be referred to as “connections.” Certain embodiments may include other communication environments such as a neighborhood environment (contacts in a user's physical proximity) and the like. In certain embodiments, the communication environments are user configurable. For example, a user may create an environment and group connections and other content into the created environment.

The grouping module 310 associates the node with, categorizes the node into, and/or groups the node into a particular cluster of the organizational structure. Each cluster may represent a group and/or branch of nodes in the organizational structure. The grouping module 310 may group nodes into particular clusters based on a user selection. For example, a user may select one or more nodes through a user interface and specify that the one or more nodes will be grouped into a particular cluster. In one embodiment, a user may create a cluster, name a cluster, and/or specify various characteristics about a cluster. For example, a user may create a cluster for “shoes,” a cluster for “hats,” and the like. In one embodiment, the grouping module 310 creates a default cluster for the organizational structure. In one embodiment, the organizational structure supports multiple levels of clustering. For example, a user, in this embodiment, may be able to form a cluster within a cluster.

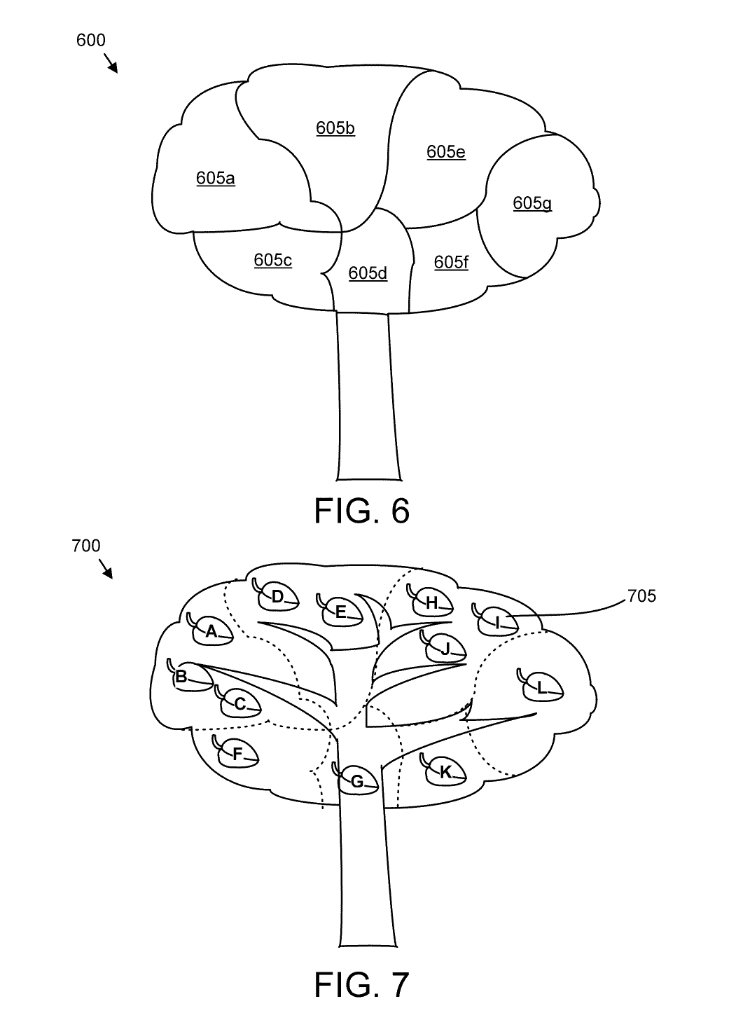

FIG. 4 depicts clusters 410 in a frame/list format. In the depicted embodiment, each cluster 410 has been named (Restaurants, Auto, and the like) and holds one or more nodes 415. Additionally, referring to FIG. 6, the clusters of the organizational structure may be visually represented by different portions of a graphically depicted organizational structure. FIG. 6 depicts an embodiment of an organizational structure represented by a tree 600. The tree 600 includes a plurality of portions 605 that may represent clusters. FIG. 7 depicts nodes 705 (pictured as leafs) grouped in various clusters of the graphically depicted organizational structure 700. In one embodiment, a user may interact with the graphically depicted organizational structure 700 (e.g. drag-and-drop leafs 705 into various cluster portions of the tree 700) and the grouping module 305 may adjust grouping of the nodes in response to the user interaction.

Referring back to FIG. 3, in one embodiment, a cluster may be a tagged cluster including tag data having description information and/or descriptive keywords associated with the cluster. The grouping module 310 may recommend to the user a cluster with which to associate a node based on the tag data. For example, if a particular cluster is tagged with keywords regarding bicycles, and a user prepares to add a node for a bike shop to the user's organizational structure, the grouping module 310 may recommend to the user to add the node to the particular cluster. In one embodiment, the user may add tag data to a cluster and/or a cluster is pre-tagged.

The depiction module 315 prepares the organizational structure for graphical depiction and/or graphically depicts the organizational structure. A graphically depicted organizational structure may be in a frame/list format, similar to the depicted organizational structure 400 in FIG. 4. In addition, the graphically depicted organizational structure may also be associated with an image, icon, and/or design as in FIG. 5, which shows the graphically depicted organizational structure as a tree 505 with a trunk 510 as the base and leafs 515 as nodes. In this embodiment, clusters may comprise various portions and/or “branches” of the tree as depicted in FIG. 7. In one embodiment, the depiction module 315 prepares the organizational structure for graphical depiction and/or graphically depicts the organizational structure by generating and/or including an image or graphic file as part of a web page served by the social networking platform 105. For example, the depiction module 315 may visually depict the organizational structure using images and HTML, with a Flash animation, and the like.

Referring to FIG. 5, although the visually depicted organizational structure 500 is depicted as comprising a tree 505 and leafs 515, any suitable visual image, icon, and/or design may be used to visually represent/depict the organizational structure 500. For example, an organizational structure 500 may be depicted as a cloud, a map, an animal, and the like. In one embodiment, a user chooses an image, icon, and/or design to represent the user's organizational structure 500. In a further embodiment, the visual representations of nodes (e.g. a leaf 515 on a tree 505) may be customized for the user and appear on the social networking platform 105 as the user's customized node representation whenever the user sees a visual representation of a node. For example, if a user has chosen a tree 505 as the user's visual representation of the organizational structure and has chose leafs 515 for node representations and the user navigates to a web page on the social networking platform 105 with one or more visual representations of nodes, those representations may appear as leafs 515 to the user.

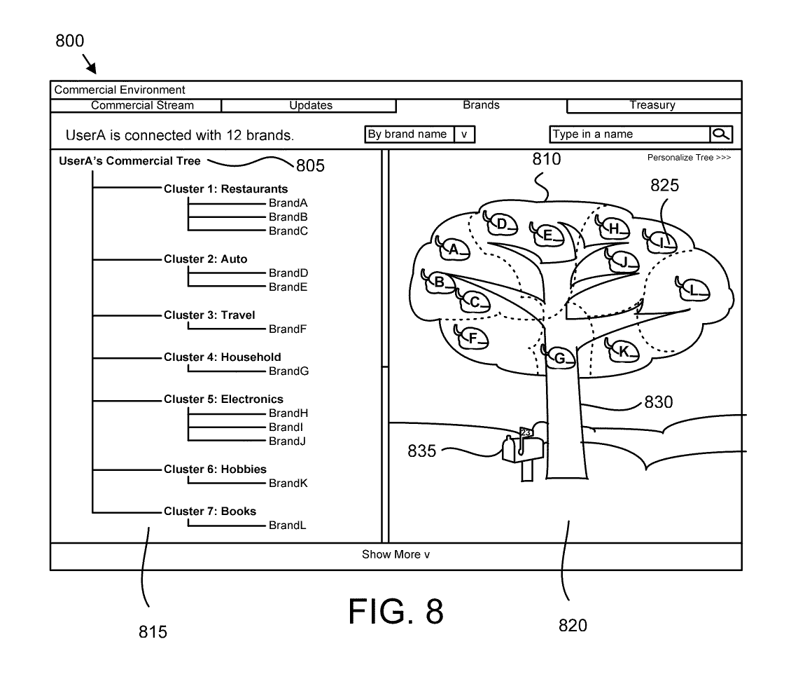

As described in the Other Application, a user may have a user suite page that may comprises a consolidated network webpage (e.g. a homepage, default loading page and/or launching page when the user logs in) on the web-based social networking platform 105 for the user account. In one embodiment, the depiction module 315 graphically depicts the organizational structure on an interface of the user suite page. FIG. 8 depicts one embodiment of graphically depicted organizational structures (both a frame/list view and a tree view) displayed in a commercial environment interface 800 for a user's commercial environment. Specifically, the depiction module 315 may depict an organizational structure in a frame/list view 805, a graphical view 810, or a hybrid view with a frame/list view 805 in a first column 815 and a graphical view 810 in a second column 820 of the interface 800.

In one embodiment, a user may associate a node with the user's organizational structure 810 (e.g. click on a leaf to add it). The node may appear at the base 830 of the organizational structure 810 until the user places the node 825 onto the organizational structure 810. For example, if a user clicks on a leaf on a website to add the leaf to the user's tree. The next time the user navigates to an interface page 800 of the user's user suite page, the leaf 825 may appear at the base of the tree 810. The user may then drag the leaf 825 onto a desired portion of the tree 810 (cluster).

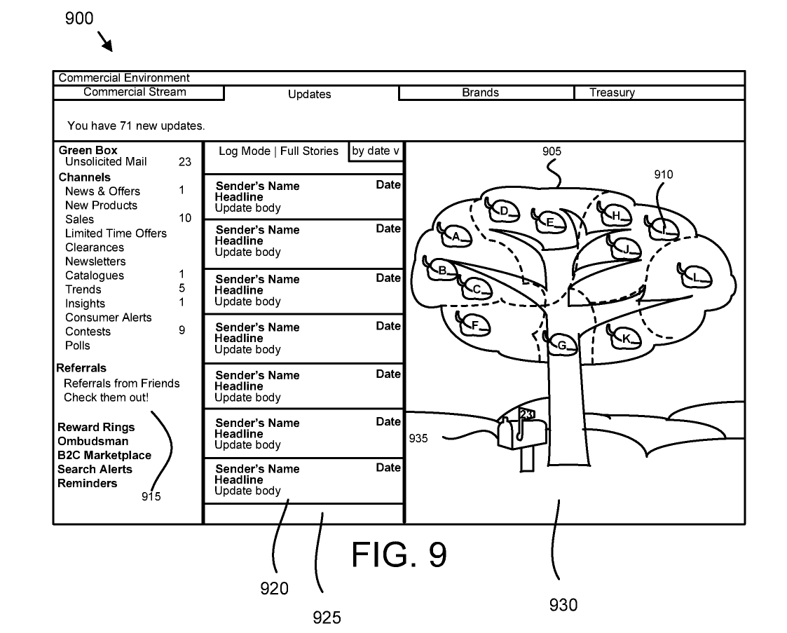

In addition, the depiction module 315 may graphically depict the organizational structure 805, 810 as a part of various other interface pages. FIG. 9 depicts an embodiment of an update interface 900 (showing received electronic messages/updates for the user) with the graphically depicted organizational structure 905. Specifically, the update interface depicts electronic messages 920 received from various entities represented by nodes 910 on the organizational structure 905. In the depicted embodiment, the user may view the tree 905 in one pane/column 930, and electronic messages in another pane 925. In one embodiment, when a user selects a particular message 920, the corresponding node 910 (representing the message sender) displays an indication (e.g. it enlarges, changes color, and the like). The update interface may list information channels and messages by information channel. In one embodiment, a node 910 may indicate how many messages (unread and/or total) are in the user's list of received messages. For example, a leaf 910 may have a number on the graphical depiction of the leaf. In addition, a node 910 may display an indication when a new message has arrived/arrives.

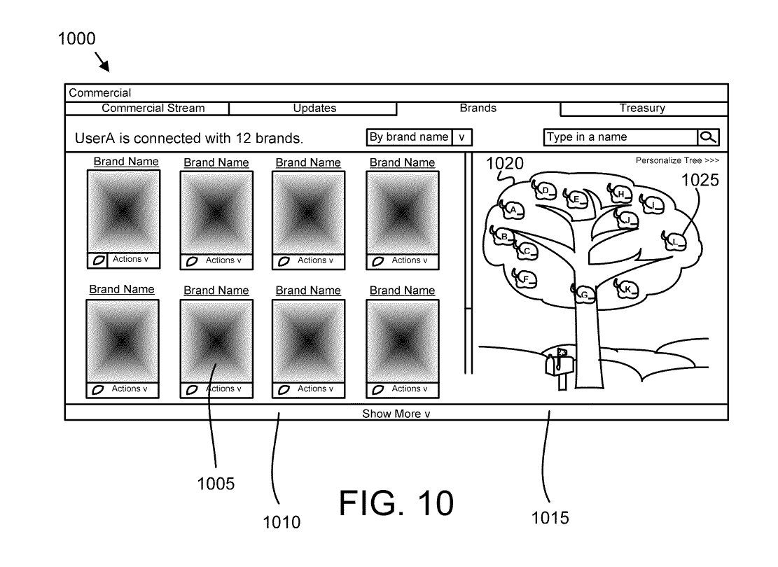

FIG. 10 depicts an embodiment of a contact interface related to a commercial environment showing various brands 1005 (commercial entity contacts) of the user in one pane 1010 and the organizational structure in another pane 1015 with nodes 1025 on the organizational structure 1020 related to the displayed brands 1005.

The graphically depicted organizational structure may be displayed to the user in any suitable form on the social networking platform 105. Furthermore, while FIGS. 9-10 depict the graphically depicted organizational structure in relation to a user's commercial environment, the graphically depicted organizational structure may also be displayed in relation to the user's other communication environments.

Referring to FIG. 8, as stated above, the graphically depicted organizational structure 810 may be responsive to interaction from the user. In one embodiment, the user is able to “drag and drop” nodes 825 on and off the organizational structure 810, zoom in on the organizational structure 810, and the like. Nodes 825 may be organized according to the user's preferences. The nodes 825 may be placed on the organizational structure 810 by the user who can drag-and-drop them onto the desired place. They may be moved at any time in the same manner.

An organizational structure 810 may drop one or more nodes 825 if re-organization is desired (e.g. the user may request that the tree 810 drop its leafs 825). In one embodiment, as stated above, after a user associates a node 825 with the user's organizational structure 810, the node 825 awaits under the organizational structure 810 to be hanged in the desired place by the user. In one embodiment, a communication channel and/or relationship with a particular entity is not formed until the user places the node 825 (for the entity) upon the organizational structure 810 by way of the visual interface.

Furthermore, each portion of the organizational structure 810 may be isolated and enlarged by clicking on it, for better viewing (e.g. a tree 810 may be enlarged to full screen and may be zoomed in and out). In one embodiment, a user may switch the display of the organizational structure 810 (e.g. switching between a list/frame view 805, a tree view 805, wireframe view, and/or a hybrid view with a combination of one or more views).

In one embodiment, graphically depicting the organizational structure 810 further comprises graphically depicting the organizational structure 810 for a first viewer differently than for a second viewer depending on a viewer identity, organizational structure visibility settings, cluster visibility settings, and/or node visibility settings. In one embodiment, when a viewer sees a user's organizational structure 810, the viewer cannot see what cluster a node 825 belongs to and/or the identity of entities belonging to nodes 825 (e.g. leafs 825 may be randomly displayed inside the tree outline 810).

Referring also to FIG. 3, in one embodiment, the depiction module 315, as a default setting, restricts user contacts from one communication environment from seeing user contacts (or detailed information for each user contact), content, and other information from other communication environments. In certain embodiments, the user may configure the visibility of information from one communication environment to another.

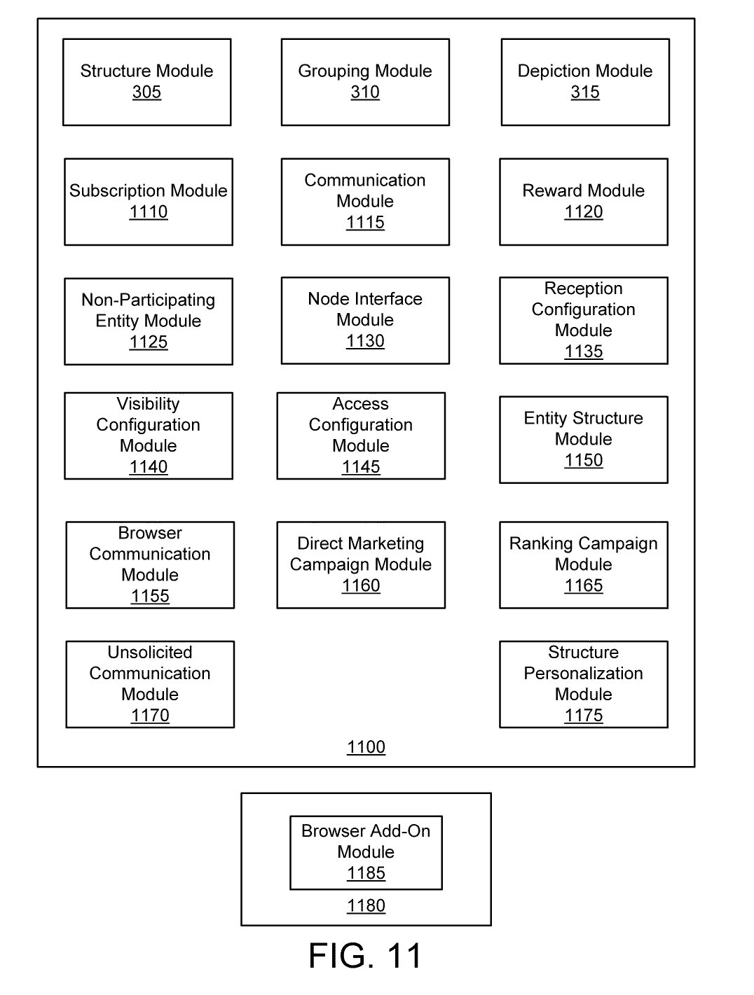

FIG. 11 depicts one embodiment of an apparatus 1100 for social media communication and contact organization. Specifically, the apparatus 1100 may comprise one embodiment of the networking contact manager 205. The description of the apparatus 1100 refers to elements of FIGS. 1-3, like numbers referring to like elements. The depicted apparatus 1100 includes a structure module 305, a grouping module 310, and a depiction module 315, wherein these modules may be substantially similar to the like-numbered modules in FIG. 3. Furthermore, the apparatus 1100 also includes a subscription module 1110, a communication module 1115, a reward module 1120, a non-participating entity module 1125, a node interface module 1130, a reception configuration module 1135, a visibility configuration module 1140, an access configuration module 1145, an entity structure module 1150, a browser communication module 1155, a direct marketing campaign module 1160, a ranking campaign module 1165, an unsolicited communication module 1170, and a structure personalization module 1175. Additionally, a portion 1180 of the apparatus 1100 may reside on the client 115 and may include a browser add-on module 1185. The portion 1180 of the apparatus on the client 115 may comprise the browser add-on 215 depicted in FIG. 2. Moreover, while the depicted embodiment includes the above listed modules, in certain embodiments, the apparatus 1100 may include a subset of the depicted modules alone and/or in various combinations.

The subscription module 1110 subscribes the user to one or more information channels for the node. As described below, the user may receive one or more electronic messages through the one or more subscribed information channels according to reception settings as described below.

The communication module 1115 communicates an electronic message from the commercial entity to the user through an information channel of the node. In one embodiment, the communication module 1115 establishes a two-way communication channel, including one or more information channels, between the user and a particular entity in response to the user adding a node associated with the particular entity to the organizational structure. In one embodiment, a visually represented node may display an indication when a message is received (e.g. a leaf changes color, enlarges, and the like).

The reward module 1120 credits the user with a reward in response to the user accessing an electronic message from a commercial entity. Accessing a message may include selecting the message, opening the message, and the like. The reward may be redeemable for discounts on purchases from the commercial entity that sent the message and/or additional commercial entities belonging to a common reward ring (contractual arrangement) with the commercial entity.

In one embodiment, nodes that offer rewards display a visual indication (e.g. a leaf may be shown with “fruit”). The node may be selected by the user to display rewards statement and history (e.g. by single clicking a fruit, the user can see the current balance and expiration of points and by double clicking the fruit, user is taken to rewards statement page and can see current statement and can go back to see previous statements from this commercial entity). A reward statement may include dates and reward points collected, dates and reward points, redeemed, balance, and/or link to dispute an entry.

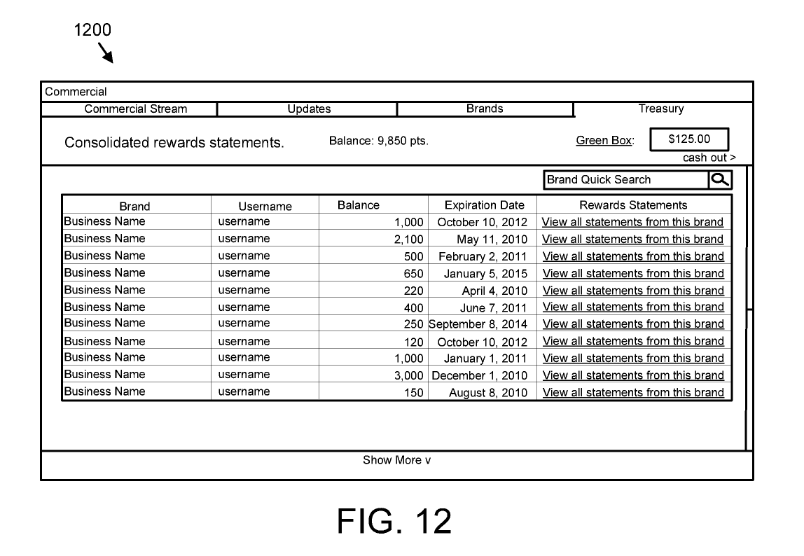

In one embodiment, a user may view a consolidated reward statement page where the rewards programs from various commercial entities are shown. Consolidated rewards statements may include commercial entity name, current balance, points expiration, and/or a link to view a full statement for each commercial entity. FIG. 12 depicts an embodiment of an environmental interface 1200 showing one embodiment of a consolidated reward statement 1200 for a user with reward information such as a commercial entity name, point balance, expiration date, and the like.

A commercial entity may participate in a rewards program by first becoming a member of the social networking website, becoming affiliated with the social networking platform 105, and/or creating an account. The commercial entity may then opt in to a rewards program, set up accrual program parameters including information channels, reward points offered per channel per update (electronic message), geographical area where consumer resides to be eligible to participate in rewards program, boost points offered when node is added for the first time (whether through browsing or referral or any other way of discovering the node inside/outside the social networking website, expiry date for rewards collected and/or the like. In one embodiment, rewards expire when a user drops the corresponding node from the user's tree.

Referring back to FIG. 11, the non-participating entity module 1125 directs an electronic message from a non-participating commercial entity to the user through an information channel of a node on the user's organizational structure turning any mailing list or feed subscription to a node that the user can place on the user's organizational structure. The non-participating commercial entity may be an entity that lacks an account on the social networking platform website. In one embodiment, the non-participating entity module 1125 may direct the structure module 305 to represent a non-participating commercial entity as a node in the organizational structure. Communication from the non-participating commercial entity may then be directed by the non-participating entity module 1125 to the node.

In one embodiment, the non-participating entity module 1125 works with the browser communication module 1155 and the browser add-on module 1185 to subscribe to subscription boxes for email communication, RSS feeds, and the like, of websites for these non-participating entities. In one embodiment, the non-participating entity module 1125 subscribes by way of a browser add on, to a subscription box (signing up a user for email communication from the entity) of a third party website. In one embodiment, the non-participating entity module 1125 generates a customized email address and supplies an email subscribe field of a third-party website with the customized email address. Messages sent to the customized email address by be received by the non-participating entity module and then forwarded on to the appropriate users.

In one embodiment, the non-participating entity module 1125 determines (e.g. checks with a database on the social networking platform 105) if any other user has subscribed to this list (the non-participating entity module 1125 has already subscribed to the particular list/subscription box), and if yes then the non-participating entity module 1125 may not generate the customized email address. In this instance, the non-participating entity module 1125 may update the database to indicate that the user may also receive communication from this non-participating entity.

The non-participating entity module 1125 associates a node on the organizational structure with the subscription box and/or non-participating commercial entity and directs messages from the non-participating entity to the node. For example, the non-participating entity module 1125 may receive a message sent to the customized email address and identify users with nodes for the non-participating entity and forward the message to these users.

The node interface module 1130 provides a node interface for display to the user, the node interface comprising a visual representation of a plurality of adjustable settings corresponding to the node. The node interface module 1130 may provide a node interface with different adjustable settings depending on whether the node is on an organizational structure for a social environment, professional environment, public environment, and the like. Moreover, each node interface may include one or more panels, each with various adjustable settings for display.

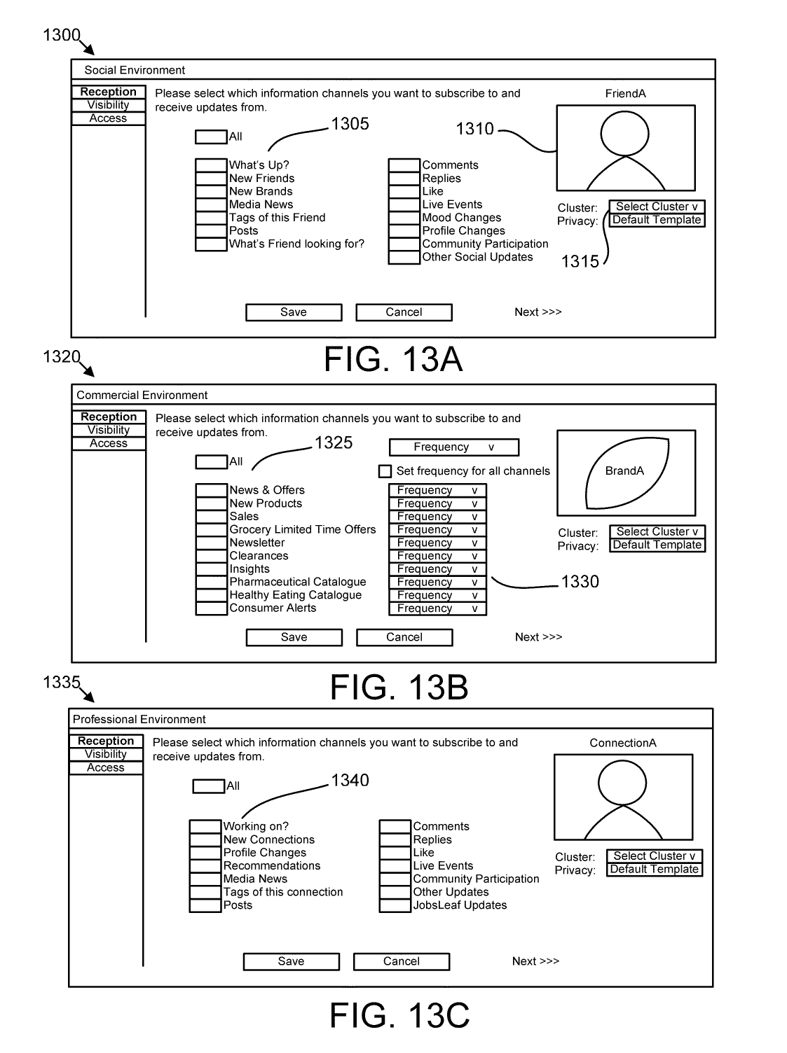

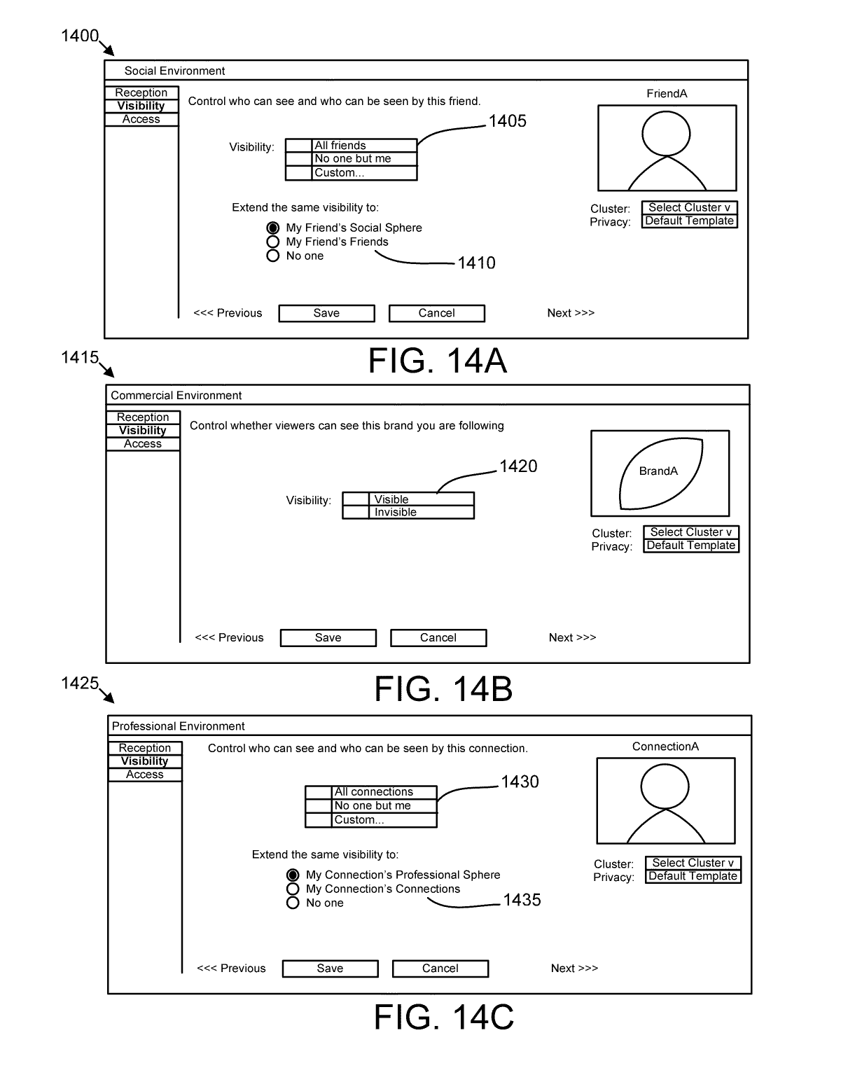

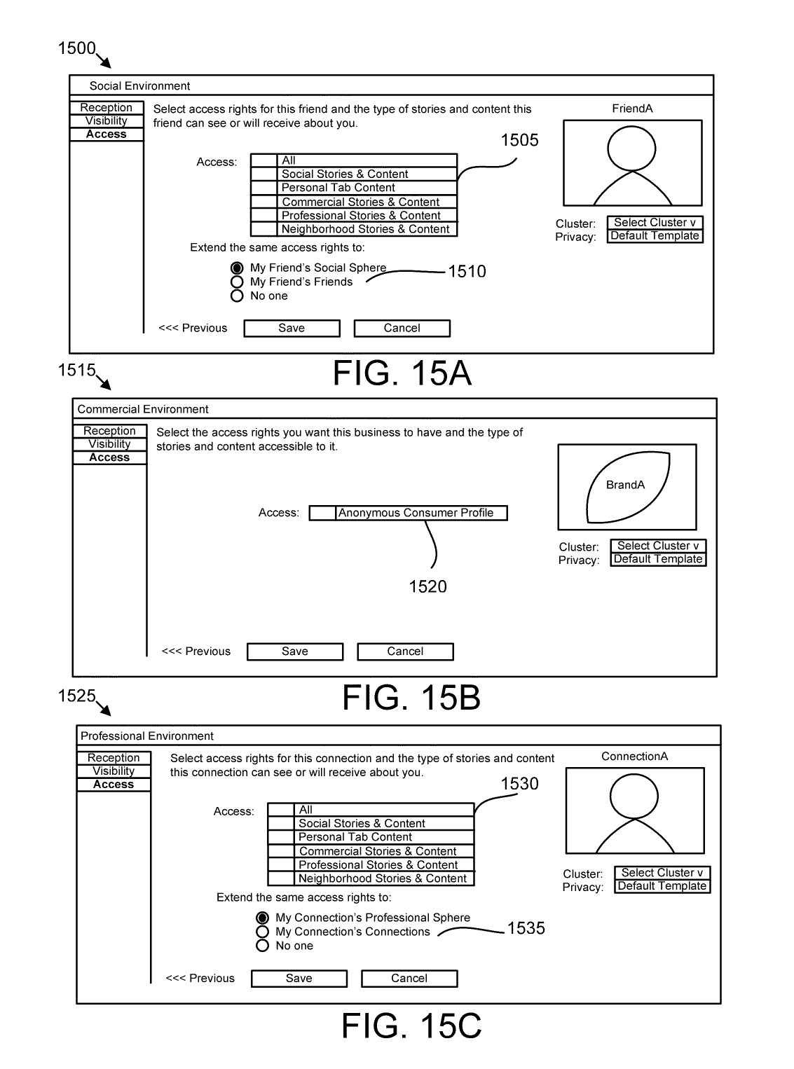

FIGS. 13A-13B depict panels of a node interface for reception settings, FIGS. 14A-14B depict panels of a node interface for visibility settings, and FIGS. 15A-15B depict panels of a node interface for access settings. The reception, visibility, and access setting panels are described below. In one embodiment, a node interface for a particular node is viewable by a user in response to the user selecting and/or clicking on the graphical representation of the node.

The reception configuration module 1135 configures, sets and/or establishes one or more reception settings for a node, node cluster, an information channel, group of information channels, an organizational structure, and the like. Reception settings may include requirements and/or specifications determining an update frequency (how often to deliver/when to check for updates), a message delivery frequency (how often to deliver/when to check for messages), a delivery time, and/or subscribed information channels. In one embodiment, the reception configuration module 1135 may establish reception settings according to user input and/or according to default settings. In certain embodiments, reception settings are set on a per-node basis. The reception configuration module 1135 may populate, read from, and/or generate a node interface.

FIG. 13A depicts one embodiment of a reception settings panel 1300 of a social environment node interface. The social environment node interface may represent settings for a particular node and include various information channels 1305 to which the user may subscribe (available from the entity corresponding to the node). In one embodiment, an entity such as a commercial entity may create and configure information channels to which the user may subscribe.

If the user contact represented by the node sends an electronic message in a category to which the user is subscribed, the user may receive the electronic message. In the depicted embodiment, the node interface includes a cluster selector 1315, an image of the user contact 1310, and the like. As stated above, the node interface and/or adjustable settings may vary depending on the type of node and/or communication environment for the node. Furthermore, FIG. 13B depicts one embodiment of a reception settings panel 1320 of a commercial environment node interface. The depicted embodiment includes various available information channels 1325 along with a frequency selection 1330. Furthermore, FIG. 13C depicts one embodiment of a reception settings panel 1335 of a professional environment node interface with corresponding available information channels 1340.

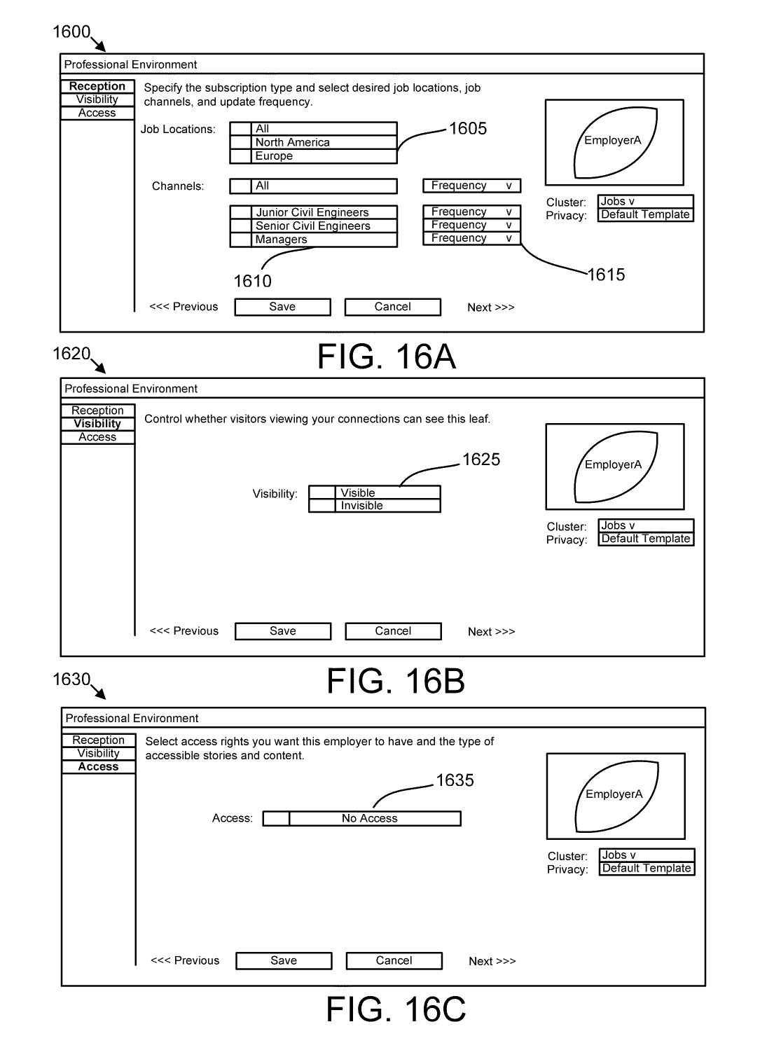

As stated above, a node may represent an entity that is a source of employment information. Consequently, a node interface may include settings related to jobs from the employment source. FIG. 16A depicts an embodiment of a reception settings panel 1600 of a job node interface for a professional environment, allowing the user to select job locations 1605, information channels 1610 (based on job type in the depicted embodiment), update frequency 1615, and the like.

Referring back to FIG. 11, the visibility configuration module 1140 configures, sets and/or establishes one or more visibility settings for a node, node cluster, an information channel, group of information channels, an organizational structure, and the like. Visibility settings may specify appearance and/or visibility to a viewer of the node, a cluster and/or the organizational structure. In one embodiment, the visibility configuration module 1140 may establish visibility settings according to user input and/or according to default settings. In certain embodiments, visibility settings are set on a per-node basis. The visibility configuration module 1140 may populate, read from, and/or generate a node interface.

FIG. 14A depicts one embodiment of a visibility settings panel 1400 of a social environment node interface with adjustable visibility settings 1430, 1435 for the user to set. Furthermore, FIG. 14B depicts one embodiment of a visibility settings panel 1415 of a commercial environment node interface and FIG. 14C depicts one embodiment of a visibility settings panel 1425 of a professional environment node interface. In addition, FIG. 16B depicts an embodiment of a visibility settings panel 1620 of a job node interface for a professional environment with adjustable settings 1625 for the job node.

Referring back to FIG. 11, the access configuration module 1145 configures, sets and/or establishes one or more access settings for a viewer of a node, node cluster, an information channel, group of information channels, an organizational structure, and the like. In one embodiment, the access configuration module 1145 may establish access settings according to user input and/or according to default settings. In certain embodiments, access settings are set on a per-node basis. The access configuration module 1145 may populate, read from, and/or generate a node interface.

FIG. 15A depicts one embodiment of an access settings panel 1500 of a social environment node interface. The access settings panel 1500 includes adjustable settings for various kinds of user content 1505. The access settings panel 1500 may also include settings on the identity of the viewer 1510. Furthermore, FIG. 15B depicts one embodiment of an access settings panel 1515 of a commercial environment node interface. In one embodiment, the commercial environment node interface does not allow a user to choose an access profile 1520 beside an anonymous profile (preventing a commercial entity from acquiring personal information about the user). Furthermore, FIG. 15C depicts one embodiment of an access settings panel 1525 of a professional environment node interface. The depicted access settings panel 1525 includes adjustable settings for various kinds of user content 1530. The depicted access settings panel 1525 may also include settings on the identity of the viewer 1535.

In addition, FIG. 16C depicts an access settings panel 1630 of a job node interface for a professional environment with one or more adjustable settings 1635 to specify access rights for the employment source.

Referring back to FIG. 11, the entity structure module 1150 may create and/or manage an organizational structure for a commercial entity, employment information source, and/or other non-standard user. The entity structure module 1150 may represent an entity contact as an entity node in an organizational structure on the social networking platform 105. The entity structure module 1150 may be similar to the structure module 305 described above. An entity node (or node in a commercial entity organizational structure, may represent a user registered to receive electronic messages from the commercial entity and/or employment information source. In one embodiment, the additional organizational structure may include a plurality of entity contacts for a plurality of users registered to receive employment information. Consequently, an employment information source, such as a commercial entity looking for job candidates, may refer to its organizational structure to view a host of potential candidates represented by nodes in the organizational structure.

The browser communication module 1155 may communicate with the browser add-on module 1185 to subscribe to subscription boxes for email communication, RSS feeds, and the like, of websites for non-participating entities. The browser communication module 1155 may receive information from the browser add-in module regarding a non-participating entity to which the user would like to subscribe. The browser communication module 1155 may communicate a customized email address to the browser add-on module 1185 to populate an email subscription box.

The direct marketing campaign module 1160 registers a commercial entity on the social networking platform 105 in a direct marketing campaign. The direct marketing campaign module 1160 may grant the commercial entity access to a plurality of consumer profiles for users on the web-based social networking platform 105 according to the direct marketing campaign. The direct marketing campaign module 1160 may receive a selection of one or more users from the commercial entity. The direct marketing campaign module 1160 may communicate a plurality of unsolicited electronic messages from the commercial entity to the one or more selected users. Each user may receive the unsolicited electronic mail at a predetermined communication channel as described below. A commercial entity may set a budget, browse and select users to send an electronic message (e.g. a teaser ad), set message expiration date (e.g. if teaser is opened after expiry date no monetary reward can be collected), set offered rewards such as monetary and/or, reward points for adding a node, and the like. The direct marketing campaign module 1160 may charge the commercial entity for enrollment in the direct marketing campaign, for messages sent, and the like. Furthermore, a user may, in one embodiment, send feedback about the unsolicited electronic message to the social networking platform 105 and/or the commercial entity.

The ranking campaign module 1165 registers a commercial entity on the social networking platform 105 in a ranking campaign. A commercial entity with nodes may participate in ranking campaign (e.g. to rank high on search/browse results against targeted words). In one embodiment, a commercial entity sets a budget, pays an enrollment fee, and the like, to join the ranking campaign. The ranking campaign module 1165 may display a representation for the commercial entity more prominently in relation to representations of one or more additional commercial entities in search results from a search by the user on the web-based networking platform. The ranking campaign module 1165 may display a visual representation of a node for the commercial entity more prominently on one or more user organizational structures in relation to additional visual representations of nodes on the user organizational structures.

The unsolicited communication module 1170 delivers unsolicited electronic messages to the user through a predetermined communication channel. In one embodiment, the unsolicited communication module 1170 credits the user with a reward in response to the user accessing an unsolicited electronic message. Referring to FIG. 9, the predetermined communication channel may be visually represented in connection with the user's organizational structure 905. In the depicted embodiment, the predetermined communication channel is represented as a mailbox 935 at the base of the tree 905.

In one embodiment, the predetermined communication channel is a brokered communication channel dedicated to unsolicited commercial communication. Commercial entities interested to form a relationship with a user may send invitations here and ask for its node to be placed on the user's organizational structure. In one embodiment, each communication sent here pays the user that reads it with a reward such as a cash reward. In one embodiment, a user that reads a communication and sends feedback obtains a reward.

In one embodiment, a user may configure the predetermined communication channel with one or more thresholds to exclude some businesses, some business categories, businesses with unacceptable reputation score and/or unacceptable reward levels. When threshold criteria is not met, the predetermined communication channel of a user may not be targeted by business and/or any messages sent may be blocked.

Referring back to FIG. 11, the browser add-on module 1185 may subscribe to a subscription box, RSS feed, and the like, of a third party website for a non-participating entity. In one embodiment, the browser add-on module 1185 supplies an email subscribe field of a third-party website with a customized email address generated by the non-participating entity module 1125

The structure personalization module 1175 allows a user to configure the user's organizational structure including characteristics of the graphical depiction of the organizational structure. In one embodiment, a user may select an image, icon, and/or design for the organizational structure. For example, the user may select a tree type, tree color, and the like.

In one embodiment, the user browses available images/designs for selection. In another embodiment, the user may upload an image/design. In one embodiment, the user may configure the background in a similar manner and choose whether to have the background follow time of day changes; follow local weather changes, follow both time of day changes and local weather changes, remain unchanged, and/or the like. The user may add, delete, and/or edit clusters and may specify cluster name, position, keywords (for tagging), description, and the like.

In one embodiment, the structure personalization module 1175 provides an interactive interface allowing the user to customize the organizational structure. A user may drag and drop nodes and/or clusters on the interface to rearrange clusters, nodes, and the like. Additionally, a user can select an organize cluster tab and organize the clusters and individual nodes that make up each cluster. In one embodiment, the structure personalization module 1175 provides a wizard with a step-by-step customization process.

In one embodiment, a user may share the user's organizational structure design, settings, and/or configuration with other users. In one embodiment, the user, through the social networking platform 105, may share the organizational structure (e.g. send another user a message with a configuration file) without sharing the contacts within the organizational structure.

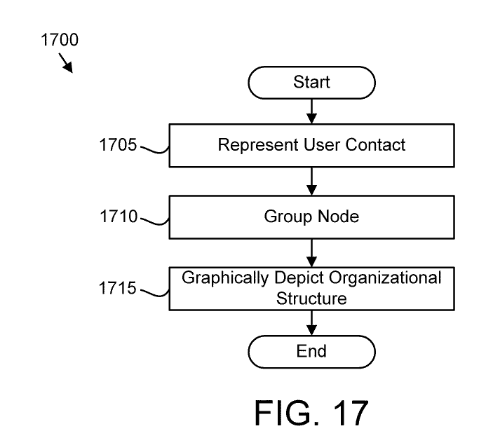

FIG. 17 depicts one embodiment of a method 1700 for social media communication and contact organization. The method 1700 may substantially include the steps to carry out at least a portion of the functions presented above with respect to the operation of the described apparatus and system of FIGS. 1-3. The description of the method 1700 refers to elements of FIGS. 1-3, like numbers referring to like elements.

In one embodiment, at least a portion of the method 1700 is implemented with a computer readable storage medium comprising a computer readable program stored on a tangible memory device and/or storage device. The computer readable storage medium may be integrated into a computer system, wherein the computer readable program executed by a processor performs the method 1700.

The method 1700 begins and the structure module 305 represents 1705 a user contact as a node in an organizational structure on a web-based social networking platform 105. The organization structure may be associated with a user. The organizational structure may include a base with one or more clusters and each cluster may be configured to hold one or more nodes. Next, the grouping module 310 associates 1710 the node with a particular cluster of the organizational structure. The node may include one or more information channels between the user contact and the user. The depiction module 315 then prepares 1715 the organizational structure for graphical depiction. In addition, the graphically depicted organizational structure may be responsive to interaction from the user. Then the method 1700 ends.

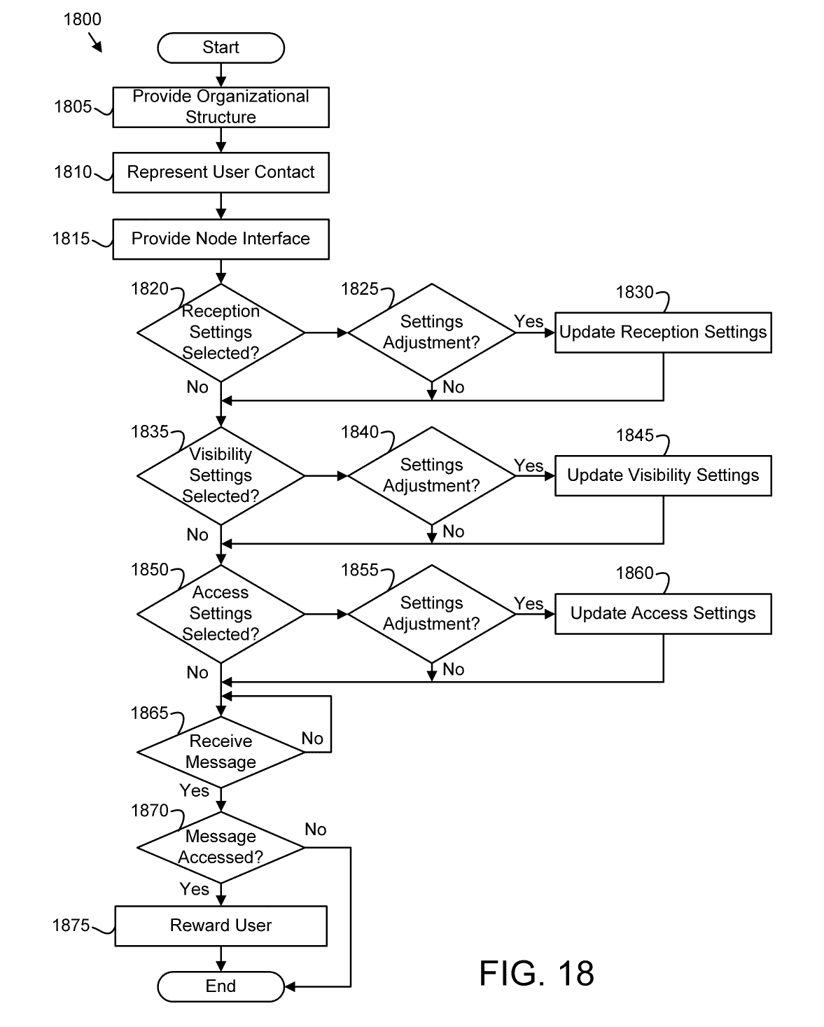

FIG. 18 depicts another embodiment of a method 1800 for social media communication and contact organization. The method 1800 may substantially include the steps to carry out at least a portion of the functions presented above with respect to the operation of the described apparatus and system of FIGS. 1-3 and 11. The description of the method 1500 refers to elements of FIGS. 1-3 and 11, like numbers referring to like elements.

In one embodiment, at least a portion of the method 1800 is implemented with a computer readable storage medium comprising a computer readable program stored on a tangible memory device and/or storage device. The computer readable storage medium may be integrated into a computer system, wherein the computer readable program executed by a processor performs the method 1800.

The method 1800 begins and the structure module 305 provides 1805 an organizational structure. The organizational structure may then represent 1810 a user contact as a node. The node interface module 1130 then provides 1815 a node interface for display to the user. The node interface may include a visual representation of a plurality of adjustable settings corresponding to the node. The reception configuration module 1135 then detects 1820 whether the user selects a reception setting indicator to adjust reception settings. In one condition, the reception configuration module 1135 detects 1820 the user select the reception setting indicator to adjust reception settings. If the reception configuration module 1135 receives 1825 setting adjustments from the user, the reception configuration module 1135 updates 1830 the reception settings based on the adjustments and the method 1800 continues with step 1835. Alternatively, the method continues with step 1835.

The visibility configuration module 1140 then detects 1835 whether the user selects a visibility setting indicator to adjust reception settings. In one condition, the visibility configuration module 1140 detects 1835 the user select the reception setting indicator to adjust visibility settings. If the visibility configuration module 1140 receives 1840 setting adjustments from the user, the visibility configuration module 1140 updates 1845 the visibility settings based on the adjustments and the method 1800 continues with step 1850. Alternatively, the method continues with step 1850.

The access configuration module 1145 then detects 1850 whether the user selects an access setting indicator to adjust reception settings. In one condition, the access configuration module 1145 detects 1850 the user select the access setting indicator to adjust access settings. If the access configuration module 1145 receives 1855 setting adjustments from the user, the access configuration module 1145 updates 1860 the access settings based on the adjustments and the method 1800 continues with step 1865. Alternatively, the method 1800 continues with step 1865.

The structure module 305 continually determines 1865 if a message is received at the node according to the reception settings. If the structure module 305 determines 1865 that a message is received and the structure module 305 determines 1870 that the user accesses the message, the reward module 1120 credits 1875 the user with a reward and the method 1800 ends. Alternatively, the method 1800 ends.

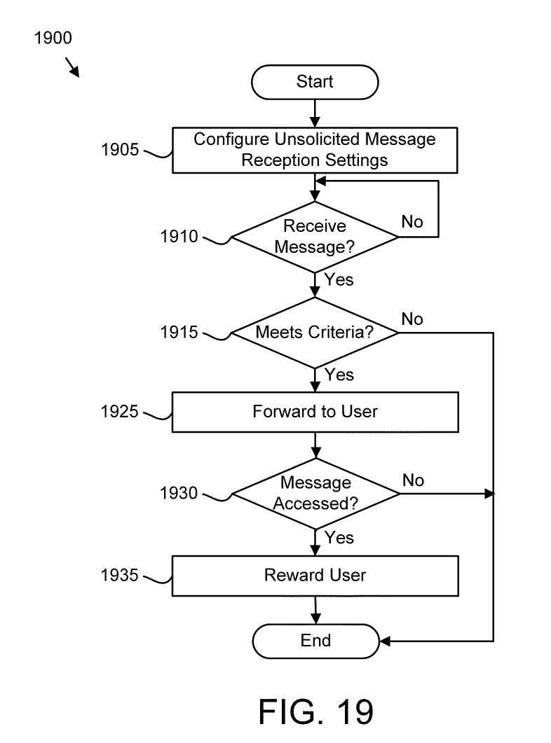

FIG. 19 depicts one embodiment of a method 1900 for social media communication and contact organization. The method 1900 may substantially include the steps to carry out at least a portion of the functions presented above with respect to the operation of the described apparatus and system of FIGS. 1-3 and 11. The description of the method 1900 refers to elements of FIGS. 1-3 and 11, like numbers referring to like elements.

In one embodiment, at least a portion of the method 1900 is implemented with a computer readable storage medium comprising a computer readable program stored on a tangible memory device and/or storage device. The computer readable storage medium may be integrated into a computer system, wherein the computer readable program executed by a processor performs the method 1500.

The method 1900 begins and the unsolicited communication module 1170 configures 1905 unsolicited message reception settings. The unsolicited message reception settings may be default settings and/or user adjusted settings. Next, the unsolicited communication module 1170 continually determines 1910 if a message is received. When the unsolicited communication module 1170 receives 1910 a message, if the unsolicited communication module 1170 determines 1915 that the message does not meet criteria specified by the unsolicited message reception settings, the method 1900 ends. Alternatively, if the unsolicited communication module 1170 determines 1915 that the message meets criteria specified by the unsolicited message reception settings, the unsolicited communication module 1170 forwards 1925 the message to the user through the predetermined communication channel. If the unsolicited communication module 1170 does not detect 1930 that the user accesses the message, the method 1900 ends. Alternatively, if the unsolicited communication module 1170 detects 1930 the user access the message, the reward module 1120 credits 1935 the user with a reward. Then, the method 1900 ends.

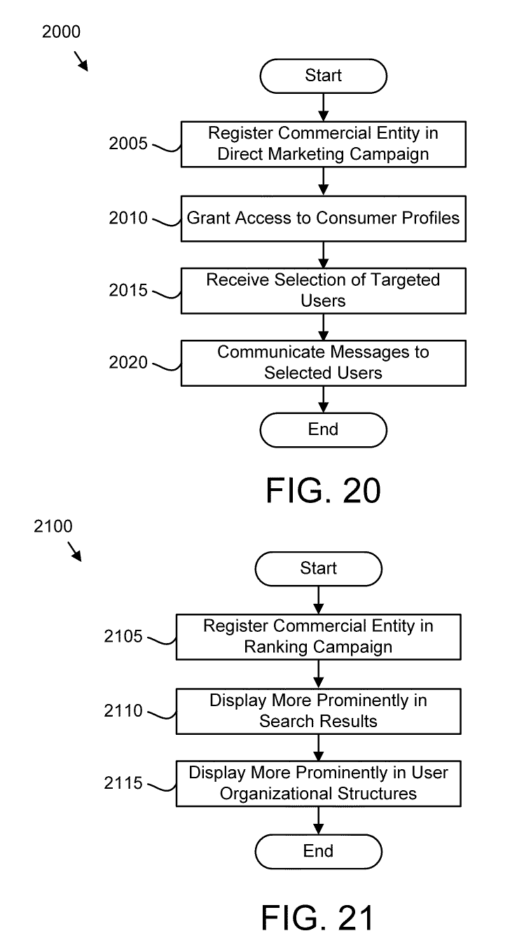

FIG. 20 depicts one embodiment of a method 2000 for a direct marketing campaign. The method 2000 may substantially include the steps to carry out at least a portion of the functions presented above with respect to the operation of the described apparatus and system of FIGS. 1-3 and 11. The description of the method 2000 refers to elements of FIGS. 1-3 and 11, like numbers referring to like elements.

In one embodiment, at least a portion of the method 2000 is implemented with a computer readable storage medium comprising a computer readable program stored on a tangible storage medium and/or storage device. The computer readable storage medium may be integrated into a computer system, wherein the computer readable program executed by a processor performs the method 2000.

The method 2000 begins and the direct marketing campaign module 1160 registers 2005 a commercial entity on the social networking platform 105 in a direct marketing campaign. Registering may include charging and/or accepting a fee from the commercial entity. The direct marketing campaign module 1160 then grants 2010 the commercial entity access to a plurality of consumer profiles for users on the web-based social networking platform 105 according to the direct marketing campaign. The direct marketing campaign module 1160 then receives 2015 a selection of one or more users from the commercial entity. Next, the direct marketing campaign module 1160 communicates 2020 a plurality of unsolicited electronic messages from the commercial entity to the one or more selected users. Then, the method 2000 ends.

FIG. 21 depicts one embodiment of a method 2100 for method for a ranking campaign. The method 2100 may substantially include the steps to carry out at least a portion of the functions presented above with respect to the operation of the described apparatus and system of FIGS. 1-3 and 11. The description of the method 2100 refers to elements of FIGS. 1-3 and 11, like numbers referring to like elements. In one embodiment, at least a portion of the method 2100 is implemented with a computer readable storage medium comprising a computer readable program stored on a tangible storage medium and/or storage device. The computer readable storage medium may be integrated into a computer system, wherein the computer readable program executed by a processor performs the method 2100.

The method 2100 begins and the ranking campaign module 1165 registers 2105 a commercial entity on the social networking platform 105 in a ranking campaign. Registering may include charging and/or accepting a fee from the commercial entity. The ranking campaign module 1165 then displays 2110 a representation for the commercial entity more prominently in relation to representations of one or more additional commercial entities in search results from a search by the user on the web-based social networking platform 105. The ranking campaign module 1165 then displays 2115 a visual representation of a node for the commercial entity more prominently on one or more user organizational structures in relation to additional visual representations of nodes on the user organizational structures. Then, the method 2100 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
representing a user contact as a node in an organizational structure on a web-based social networking platform, the organization structure associated with a user, the organizational structure comprising a base with one or more clusters, each cluster configured to hold one or more nodes;
grouping the node into a particular cluster of the organizational structure, the node comprising one or more information channels between the user contact and the user; and
graphically depicting the organizational structure, the graphically depicted organizational structure responsive to interaction from the user.

2. The method of claim 1, wherein the organizational structure is graphically depicted as a tree, the base is graphically depicted as a tree trunk, and each node is graphically depicted as a leaf.

3. The method of claim 1, further comprising subscribing the user to one or more information channels for the node and communicating one or more electronic messages through the one or more subscribed information channels.

4. The method of claim 1, further comprising providing a node interface for display to the user, the node interface comprising a visual representation of a plurality of adjustable settings corresponding to the node.

5. The method of claim 1, further comprising:
configuring one or more reception settings for one or more of the node and the one or more information channels, the one or more reception settings comprising one or more of an update frequency, a message delivery frequency, a message delivery time, and subscribed information channels;
configuring one or more visibility settings for one or more of the node, the particular cluster, and the organizational structure, the one or more visibility settings specifying one or more of appearance and visibility to a viewer of one or more of the node, the particular cluster and the organizational structure; and
configuring one or more access settings for one or more of the node, the particular cluster, and the organizational structure, the one or more access settings specifying one or more of access and visibility of one or more of the node, the particular cluster and the organizational structure to one or more of the user contact and a viewer.

6. The method of claim 1, wherein graphically depicting the organizational structure further comprises graphically depicting the organizational structure for a first viewer differently than for a second viewer depending on one or more of a viewer identity, organizational structure visibility settings, cluster visibility settings, and node visibility settings.

7. The method of claim 1, wherein the node is associated with a commercial entity and wherein the method further comprises communicating an electronic message from the commercial entity to the user through an information channel of the node and crediting the user with a reward in response to the user accessing the electronic message, wherein the reward is redeemable for discounts on purchases from one or more of the commercial entity and additional merchant entities belonging to a common reward ring with the commercial entity.

8. The method of claim 1, wherein the node is associated with a non-participating commercial entity and wherein the method further comprises directing an electronic message from the non-participating commercial entity to the user through an information channel of the node.

9. The method of claim 1, further comprising associating an additional node representing an additional user contact with the organizational structure in response to one of receiving a signal from a commercial entity that the user requested to associate the commercial entity with the organizational structure, detecting the user visually associate a visual representation of the additional node with the graphically depicted organizational structure, and detecting the user select the visual representation of the additional node on the social networking platform.

10. The method of claim 1, wherein the node is associated with an employment information source, the method further comprising communicating employment information from the employment information source through the one or more information channels.

11. The method of claim 1, further comprising representing an entity contact as an entity node in an additional organizational structure on the social networking platform, the additional organization structure associated with an entity, the entity comprising an employment information source, the entity node representing a user registered to receive employment information from the entity, the additional organizational structure comprising a plurality of entity contacts for a plurality of users registered to receive employment information.

12. The method of claim 1, further comprising delivering unsolicited electronic messages to the user through a predetermined communication channel and crediting the user with a reward in response to the user accessing an unsolicited electronic message.

13. The method of claim 1, further comprising:
registering a commercial entity on the social networking platform in a direct marketing campaign;
granting the commercial entity access to a plurality of consumer profiles for users on the web-based social networking platform according to the direct marketing campaign;
receiving a selection of one or more users from the commercial entity; and
communicating a plurality of unsolicited electronic messages from the commercial entity to the one or more selected users.

14. The method of claim 1, further comprising:
registering a commercial entity on the social networking platform in a ranking campaign;
displaying a representation for the commercial entity more prominently in relation to representations of one or more additional commercial entities in search results from a search by the user on the web-based networking platform; and
displaying a visual representation of a node for the commercial entity more prominently on one or more user organizational structures in relation to additional visual representations of nodes on the user organizational structures.

15. A computer readable storage medium having computer readable program code embodied therewith, the computer readable program code executable to perform operations comprising:
maintaining a user contact as a node in an organizational structure on a web-based social networking platform, the organization structure associated with a user, the organizational structure comprising a base with one or more clusters, each cluster configured to hold one or more nodes;
categorizing the node into a particular cluster of the organizational structure based on a user selection, the node comprising one or more information channels between the user contact and the user; and
graphically representing the organizational structure, the graphically depicted organizational structure responsive to interaction from the user.

16. The computer readable storage medium of claim 15, the operations further comprising:
establishing one or more reception settings for one or more of the node and the one or more information channels, the one or more reception settings comprising one or more of an update frequency, a message delivery frequency, a message delivery time, and subscribed information channels;
establishing one or more visibility settings for one or more of the node, the particular cluster, and the organizational structure, the one or more visibility settings specifying one or more of appearance and visibility to a viewer of one or more of the node, the particular cluster and the organizational structure; and
establishing one or more access settings for one or more of the node, the particular cluster, and the organizational structure, the one or more access settings specifying one or more of access and visibility of one or more of the node, the particular cluster and the organizational structure to one or more of the user contact and a viewer.

17. The computer readable storage medium of claim 15, wherein the node is associated with a commercial entity and wherein the operations further comprise communicating an electronic message from the commercial entity to the user through an information channel of the node and crediting the user with a reward in response to the user accessing the electronic message, wherein the reward is redeemable for discounts on purchases from one or more of the commercial entity and additional merchant entities belonging to a common reward ring with the commercial entity.

18. The computer readable storage medium of claim 15, wherein the node is associated with a non-participating commercial entity and wherein the operations further comprise directing an electronic message from the non-participating commercial entity to the user through an information channel of the node.

19. An apparatus comprising:
a structure module configured to represent a user contact as a node in an organizational structure on a web-based social networking platform, the organization structure associated with a user, the organizational structure comprising a base with one or more clusters, each cluster configured to hold one or more nodes;
a grouping module configured to associate the node with a particular cluster of the organizational structure, the node comprising one or more information channels between the user contact and the user; and
a depiction module configured to prepare the organizational structure for graphical depiction, the graphically depicted organizational structure responsive to interaction from the user.

20. The apparatus of claim 19, further comprising a subscription module configured to subscribe the user to one or more information channels for the node and a communication module configured to communicate one or more electronic messages through the one or more subscribed information channels.

21. The apparatus of claim 19, further comprising a node interface module configured to provide a node interface for display to the user, the node interface comprising a visual representation of a plurality of adjustable settings corresponding to the node.

22. The apparatus of claim 19, further comprising:
a reception configuration module configured to set one or more reception settings for one or more of the node and the one or more information channels, the one or more reception settings comprising one or more of an update frequency, a message delivery frequency, a message delivery time, and subscribed information channels;
a visibility configuration module configured to set one or more visibility settings for one or more of the node, the particular cluster, and the organizational structure, the one or more visibility settings specifying one or more of appearance and visibility to a viewer of one or more of the node, the particular cluster and the organizational structure; and
an access configuration module configured to set one or more access settings for one or more of the node, the particular cluster, and the organizational structure, the one or more access settings specifying one or more of access and visibility of one or more of the node, the particular cluster and the organizational structure to one or more of the user contact and a viewer.

23. The apparatus of claim 19, wherein the node is associated with a commercial entity and wherein the apparatus further comprises a communication module configured to communicate an electronic message from the commercial entity to the user through an information channel of the node, the apparatus further comprising a reward module configured to credit the user with a reward in response to the user accessing the electronic message, wherein the reward is redeemable for discounts on purchases from one or more of the commercial entity and additional merchant entities belonging to a common reward ring with the commercial entity.

24. The apparatus of claim 19, further comprising a entity structure module configured to represent a commercial entity contact as a commercial entity node in an additional organizational structure on the social networking platform, the additional organization structure associated with a commercial entity, the commercial entity node representing a user registered to receive employment information from the commercial entity, the additional organizational structure comprising a plurality of commercial entity contacts for a plurality of users registered to receive employment information.

25. A system comprising:
a server configured to communicate with one or more clients over a network, the server comprising:
a structure module configured to representing a user contact as a node in an organizational structure on a web-based social networking platform, the organization structure associated with a user, the organizational structure comprising a base with one or more clusters, each cluster configured to hold one or more nodes;
a grouping module configured to group the node into a particular cluster of the organizational structure, the node comprising one or more information channels between the user contact and the user; and
a depiction module configured to graphically depict the organizational structure, the graphically depicted organizational structure responsive to interaction from the user.
